(19) United States
(12) Patent Application Publication
(10) Pub. No.: US 2011/0040769 A1
(43) Pub. Date: Feb. 17, 2011

(54) Query-URL N-Gram Features in Web Ranking

(75) Inventors: Huihsin Tseng, Mountain View, CA (US); Longbin Chen, Sunnyvale, CA (US); Yumao Lu, San Jose, CA (US); Fachun Peng, Sunnyvale, CA (US)

Correspondence Address: BAKER BOTTS L.L.P., 2001 ROSS AVENUE, 6TH FLOOR, DALLAS, TX, 75201, US

(73) Assignee: Yahoo! Inc., Sunnyvale, CA (US)

(21) Appl. No.: 12/541,063

(22) Filed: Aug. 13, 2009

(51) Int. Cl. G06F 17/30

(52) U.S. Cl. 707/750; 707/E17.112; 707/E17.032; 707/E17.014

(57) ABSTRACT

In one embodiment, access one or more pairs of search query and clicked Uniform Resource Locator (URL). For each of the pairs of search query and clicked URL, segment the search query into one or more query segments and the clicked URL into one or more URL segments; construct one or more query-URL n-grams, each of which comprises a query part comprising at least one of the query segments and a URL part comprising at least one of the URL segments; and calculate one or more association scores, each of which for one of the query-URL n-grams and represents a similarity between the query part and the URL part of the query-URL n-gram and is based on a first frequency of the query part and the URL part, a second frequency of the query part, and a third frequency of the URL part.

### TECHNICAL FIELD

The present disclosure generally relates to improving search engine performance.

### BACKGROUND

The Internet provides a vast amount of information. The individual pieces of information are often referred to as “network resources” or “network contents” and may have various formats, such as, for example and without limitation, texts, audios, videos, images, web pages, documents, executables, etc. The network resources or contents are stored at many different sites, such as on computers and servers, in databases, etc., around the world. These different sites are communicatively linked to the Internet through various network infrastructures. Any person may access the publicly available network resources or contents via a suitable network device, e.g., a computer, connected to the Internet.

However, due to the sheer amount of information available on the Internet, it is impractical as well as impossible for a person, e.g., a network user, to manually search throughout the Internet for specific pieces of information. Instead, most people rely on different types of computer-implemented tools to help them locate the desired network resources or contents. One of the most commonly and widely used tools is a search engine, such as the search engines provided by Yahoo!® Inc. (http://search.yahoo.com) and Google™ (http://www.google.com). To search for information relating to a specific subject matter on the Internet, a network user typically provides a short phrase describing the subject matter, often referred to as a “search query”, to a search engine. The search engine conducts a search based on the query phrase using various search algorithms and generates a search result that identifies network resources or contents that are most likely to be related to the search query. The network resources or contents are presented to the network user, often in the form of a list of links, each link being associated with a different web page that contains some of the identified network resources or contents. In particular embodiments, each link is in the form of a Uniform Resource Locator (URL) that specifies where the corresponding web page is located and the mechanism for retrieving it. The network user is then able to click on the URL links to view the specific network resources or contents contained in the corresponding web pages as he wishes.

Sophisticated search engines implement many other functionalities in addition to merely identifying the network resources or contents as a part of the search process. For example, a search engine usually ranks the identified network resources or contents according to their relative degrees of relevance with respect to the search query, such that the network resources or contents that are relatively more relevant to the search query are ranked higher and consequently are presented to the network user before the network resources or contents that are relatively less relevant to the search query. The search engine may also provide a short summary of each of the identified network resources or contents.

There are continuous efforts to improve the qualities of the search results generated by the search engines. Accuracy, completeness, presentation order, and speed are but a few of the performance aspects of the search engines for improvement.

### SUMMARY

The present disclosure generally relates to improving search engine performance.

According to particular embodiments, access one or more pairs of search query and clicked Uniform Resource Location (URL), the clicked URL identifying a network resource that has been identified by a search engine in response to the search query, the clicked URL having been clicked by a user who has issued the search query to the search engine. For each of the pairs of search query and clicked URL, segmenting the search query into one or more query segments; segmenting the clicked URL into one or more URL segments; constructing one or more query-URL n-grams, each of which comprises a query part and a URL part, the query part comprising at least one of the query segments, the URL part comprising at least one of the URL segments; and calculating one or more association scores each of which for one of the query-URL n-grams, for each of the query-URL n-grams, its association score represents a similarity between the query part and the URL part of the query-URL n-gram and is calculated based on a first frequency of the query part and the URL part of the query-URL n-gram appearing in all of the pairs of search query and clicked URL, a second frequency of the query part of the query-URL n-gram appearing in all of the search queries of all of the pairs of search query and clicked URL, and a third frequency of the URL part of the query-URL n-gram appearing in all of the clicked URLs of all of the pairs of search query and clicked URL.

These and other features, aspects, and advantages of the disclosure are described in more detail below in the detailed description and in conjunction with the following figures.

### BRIEF DESCRIPTION OF THE DRAWINGS

FIG. 1 illustrates an example search result.

FIG. 2 illustrates an example method of determining associations between search queries and clicked URLs.

FIG. 3 illustrates an example network environment

FIG. 4 illustrates an example computer system.

### DETAILED DESCRIPTION

The present disclosure is now described in detail with reference to a few embodiments thereof as illustrated in the accompanying drawings. In the following description, numerous specific details are set forth in order to provide a thorough understanding of the present disclosure. It is apparent, however, to one skilled in the art, that the present disclosure may be practiced without some or all of these specific details. In other instances, well known process steps and/or structures have not been described in detail in order not to unnecessarily obscure the present disclosure. In addition, while the disclosure is described in conjunction with the particular embodiments, it should be understood that this description is not intended to limit the disclosure to the described embodiments. To the contrary, the description is intended to cover alternatives, modifications, and equivalents as may be included within the spirit and scope of the disclosure as defined by the appended claims.

A search engine is a computer-implemented tool designed to search for information on a network, such as the Internet or the World Wide Web. To conduct a search, a network user may issue a search query to the search engine. In response, the search engine may identify one or more network resources that are likely to be related to the search query, which may collectively be referred to as a “search result” identified for the search query. The network resources are usually ranked and presented to the network user according to their relative degrees of relevance to the search query.

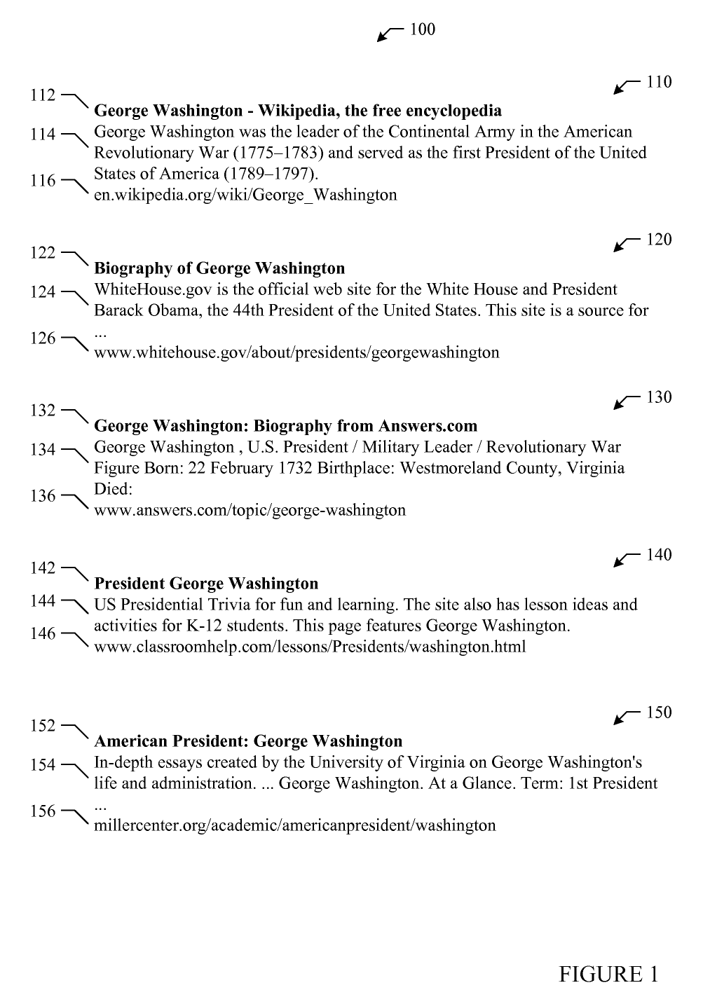

FIG. 1 illustrates an example search result 100 that identifies five network resources and more specifically, five web pages 110, 120, 130, 140, 150. Search result 100 is generated in response to an example search query “President George Washington”. Note that only five network resources are illustrated in order to simplify the discussion. In practice, a search result may identify hundreds, thousands, or even millions of network resources. Network resources 110, 120, 130, 140, 150 each includes a title 112, 122, 132, 142, 152, a short summary 114, 124, 134, 144, 154 that briefly describes the respective network resource, and a clickable link 116, 126, 136, 146, 156 in the form of a URL. For example, network resource 110 is a web page provided by WIKIPEDIA that contains information concerning George Washington. The URL of this particular web page is “en.wikipedia.org/wiki/George_Washington”.

Network resources 110, 120, 130, 140, 150 are presented according to their relative degrees of relevance to search query “President George Washington”. That is, network resource 110 is considered somewhat more relevant to search query “President George Washington” than network resource 120, which is in turn considered somewhat more relevant than network resource 130, and so on. Consequently, network resource 110 is presented first, i.e., at the top of search result 100, followed by network resource 120, network resource 130, and so on. To view any of network resource 110, 120, 130, 140, 150, the network user requesting the search may click on the individual URLs of the specific web pages.

In particular embodiments, the ranking of the network resources with respect to the search queries may be determined by a ranking algorithm implemented by the search engine. Given a search query and a set of network resources identified in response to the search query, the ranking algorithm ranks the network resources in the set according to their relative degrees of relevance with respect to the search query. More specifically, in particular embodiments, the network resources that are relatively more relevant to the search query are ranked higher than the network resources that are relatively less relevant to the search query, as illustrated, for example, in FIG. 1.

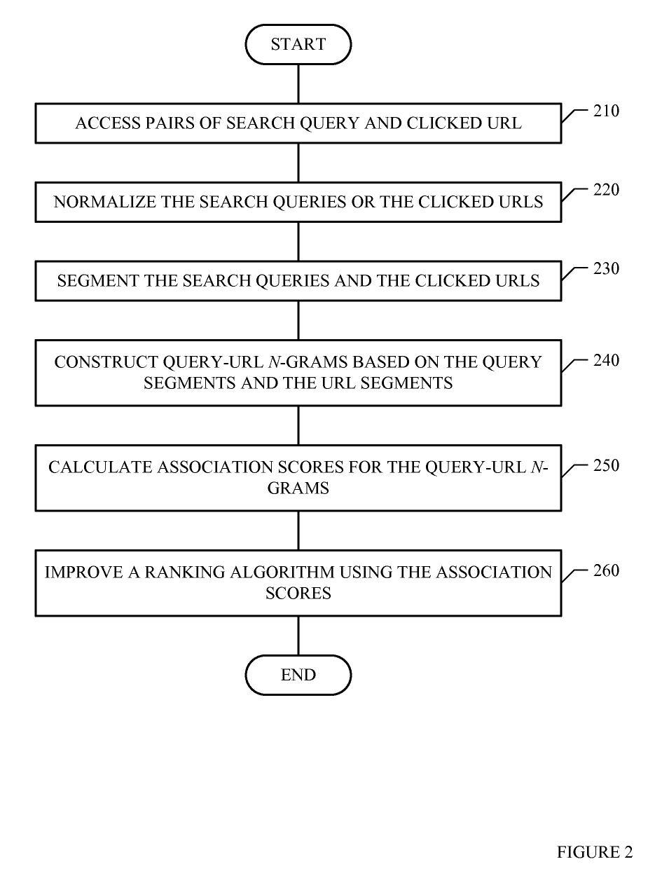

As indicated above, in practice, a search engine may identify hundreds, thousands, or even millions of individual network resources, e.g., web pages, in response to a search query depending on the popularity or the commonness of the subject matter described by the search query. For example, in response to the search query “President George Washington”, the search engine provided by Yahoo!® Inc. identifies approximately 105,000,000 web pages. It is very unlikely that a network user requesting a search is able to click on the URL link of every identified web page included in the search result to view its content. Instead, the network user may click on the URL links of a few selected web pages that appear to be most interesting to the network user. For example, in FIG. 2, a network user may click on URL links 116 and 136 to view network resources 110 and 130 but ignore the other network resources.

Often, it is likely that the network resources selected by the network users for further viewing by selecting their URL links are considered by the network users as providing or likely to provide the type of information that the network users are searching for via the search process. Of course, the network users do not necessarily always click on the top-ranked network resources included in the search results. For example, sometimes, a network user may find the 20th ranked network resource more interesting than the first ranked network resource and click on the URL link of the 20th ranked network resource but ignore the URL link of the first ranked network resource. Empirical data suggest that if a URL of a network resource identified in response to a search query receives a large number of first and last clicks across many user sessions by many different network users, then the network resource having the URL may be strongly preferred with respect to the search query. It may then be inferred that the network resources whose URL links having been clicked on by the network users are considered by the network users to be more relevant to the corresponding search queries. Consequently, the URL links that are clicked on by the network users, i.e., the clicked URL links, in response to specific search queries may indicate and thus may be used to predict the relevance of the network resources identified by the clicked URL links with respect to those search queries.

Particular embodiments may determine the associations between the search queries and their corresponding clicked URLs and use such associations to improve the ranking functionalities of a search engine. Particular embodiments may analyze one or more pairs of search query and clicked URL. More specifically, each pair of search query and clicked URL includes a search query and a URL of a network resource; and for each pair of search query and clicked URL, the network resource having the URL has been identified by a search engine in response to the search query, and the URL link of the network resource has been clicked on by the network user issuing the search query to the search engine. For example, in FIG. 2, suppose the network user issuing the search query “President George Washington” has clicked on URL links 116 and 136. As a result, there are two pairs of search query and clicked URL: <President George Washington, en.wikipedia.org/wiki/George_Washington> and <President George Washington, www.answers.com/topic/george-washington>.

Particular embodiments may analyze pairs of search query and clicked URL obtained from multiple searches conducted by one or more search engines. Thus, there may be different search queries; the clicked URLs may be identified in different search results; and the URL links may be clicked on by different network users. Particular embodiments may construct a dictionary based on the pairs of search query and clicked URL and determine associations between portions of search queries and portions of clicked URLs. The associations may then be used to improve the performance of the ranking functionalities of a search engine.

FIG. 2 illustrates an example method of determining associations between search queries and clicked URLs. Particular embodiments may monitor network traffic at one or more search engines and collect information, such as the search queries issued to the search engines by network users, the network resources identified by the search engines in response to the individual search queries and their URLs, the URL links clicked on by the network users issuing the search queries, etc. Particular embodiments may store the information in one or more log files, such as click-through logs. From the network traffic information, one or more pairs of search query and clicked URL may be obtained, as illustrated in step 210. As indicated above, each pair of search query and clicked URL includes a search query and a URL of a network resource, e.g., a web page. The network resource has been identified by a search engine in response to the search query; and the URL of the network resource has been clicked on by a network user issuing the search query to the search engine and requesting the search.

The following TABLE 1 illustrates several example pairs of search query and clicked URL. Again, only a few pairs of search query and clicked URL are illustrated to simplify the discussion. In practice, there is no limit on the number of pairs of search query and clicked URL that may be analyzed together. Note that a particular clicked URL may correspond to multiple search queries. For example, in TABLE 1, example clicked URL “www.apple.com/iphone” may be identified in response to both example search queries “iphone” and “iphone plan” and may have been clicked by the network users issuing those two search queries to the search engine.

TABLE 1
Example Pairs of Search Query and Clicked URL

| Search Query | Clicked URL |
|---|---|
| IRS 1040 form | www.irs.gov |
| IRS 1040 form | www.irs.gov/pub/irs-pdf/f1040.pdf |
| irs 1040 form | www.irs.gov/pub/irs-pdf/f1040es.pdf |
| iphone | www.apple.com/iphone |
| iphone | www.amazon.com/tag/iphone |
| iPhone plan | att.com |
| iPhone plan | www.apple.com/iphone |
| Japanese kanji translation | www.saiga-jp.com/kanji_dictionary.html |
| Japanese kanji translation | nihongo.j-talk.com |
| name@myspace.com | www.myspace.com/name |

Particular embodiments may normalize the search queries or the clicked URLs in the pairs of search query and clicked URL, as illustrated in step 220. Particular embodiments may convert the characters in the search queries and the clicked URLs either all to upper case or all to lower case. Often, different network users may use different cases for characters of a particular word. Similarly, when selecting path and file names for network resources, different website developers may use different cases for characters of a particular word. For example, “irs” and “IRS” both refer to the same government entity, and “iphone” and “iPhone” both refer to the same electronic device. Particular embodiments may treat words spelled using different cases of characters, e.g., “irs” and “IRS”, as the same word and normalize the characters of all of the search queries and the clicked URLS either all to upper case characters or all to lower case characters.

Particular embodiments may normalize the search queries by removing all of the punctuation marks from all of the search queries and replacing them with spaces. In particular embodiments, a punctuation mark is any symbol other than the letters in the alphabet and the numerical digits. Examples of punctuation marks or symbols may include, without limitation, “/”, “\”, “,”, “.”, “;”, “!”, “?”, “&”, “$”, “#”, “@”, “%”, “*”, “(”, “)”, “[”, “]”, “{”, “}”, “-”, “_”, “=”, etc. For example, the example search query “name myspace.com” in TABLE 1 may be normalized to “name myspace com” by replacing the punctuation marks “@” and “.” with spaces.

Particular embodiments segment each of the optionally normalized search queries into one or more segments and each of the optionally normalized clicked URLs into one or more segments, as illustrated in step 230. There are many different ways to segment a search query or a clicked URL. The present disclosure contemplates any suitable method to segment a search query and a clicked URL.

For example, particular embodiments may segment each search query into one or more segments divided by white spaces and each clicked URL into one or more segments divided by punctuation marks In particular embodiments, a white space is any blank area between characters or numerical digits, such as a space, a tab, or a carriage return. Note that the white spaces in a normalized search query may be included in the original search query as it has been issued to the search engine or may be replacements for the punctuation marks included in the original search query while the search query is normalized.

Particular embodiments may segment each search query into one or more segments using a generative query model to recover a search query's underlying concepts that compose its original segmented form. Using a generative query model to segment search queries is described in more detail in Unsupervised query segmentation using generative language models and Wikipeida, by Bin Tan and Fuchun Peng, Proceedings of the 17th International World Wide Web Conference (WWW 2008), pages 347-356, Beijing, China, Apr. 21-25, 2008.

Latin-based languages are not the only languages existing on the Internet. Many network resources may be written in non-Latin-based languages such as Chinese, Japanese, Korean, Hindi, Arabic, etc. Similarly, not all search queries are provided in Latin-based languages as well. Different segmentation methods may be used to segment search queries in different languages. For example, particular embodiments may use linear-chain conditional random fields (CRFs) to segment search queries in Chinese, as described in more detail in Chinese segmentation and new world detection using conditional random fields, by Fuchun Peng, Fangfang Feng, and Andrew McCallum, Proceedings of The 20th International Conference on Computational Linguistics (COLING 2004), pages 562-568, Aug. 23-27, 2004, Geneva, Switzerland.

In particular embodiments, a segment may include one or more letters or numerical digits. In particular embodiments, a segment may also include one or more punctuation marks. For clarification purposes, hereafter, the segments obtained from segmenting the normalized search queries are referred to as the “query segments”, and the segments obtained from segmenting the optionally normalized clicked URLs are referred to as the “URL segments”.

The following TABLE 2 illustrates the query segments of the example search queries illustrated in TABLE 1 after the example search queries have been normalized. Note that multiple search queries often may share one or more common words. For example, in TABLE 1, example search queries “iphone” and “iphone plane” share a common word “iphone.” Thus, “iphone” is a query segment common to both example search queries “iphone” and “iphone plane”.

TABLE 2
Query Segments of the Example Search Queries

| Search Query | Query Segment |
|---|---|
| irs 1040 form | irs |
| | 1040 |
| | form |
| iphone | iphone |
| iphone plan | iphone |
| | plan |
| japanese kanji translation | Japanese |
| | kanji |
| | translation |
| name myspace com | name |
| | myspace |
| | com |

Particular embodiments segment each of the optionally normalized clicked URLs into one or more segments divided by punctuation marks. In general, a URL represents the location path of the network resource it identifies and is delimited by punctuation marks such as “?”, “.”, “/”, or “=”.

In particular embodiments, every punctuation mark in each clicked URL may be used to segment the clicked URL. The following TABLE 3A illustrates the URL segments of the example clicked URLs illustrated in TABLE 1 where every punctuation mark in each example clicked URL is used as a divider. Note that multiple clicked URLs may often share one or more common words. For example, many URLs include words such as “www”, “com”, “org”, “edu”, etc. Clicked URLs from the same domain usually share the same domain name. Thus, the same URL segment may be common to multiple clicked URLs.

TABLE 3A
URL Segments of the Example Clicked URLs

| | URL |
|---|---|
| Clicked URL | Segment |
| www.irs.gov | www |
| | irs |
| | gov |
| www.irs.gov/pub/irs-pdf/f1040.pdf | www |
| | irs |
| | gov |
| | pub |
| | irs |
| | pdf |
| | f1040 |
| | pdf |
| www.irs.gov/pub/irs-pdf/f1040es.pdf | www |
| | irs |
| | gov |
| | pub |
| | irs |
| | pdf |
| | f1040es |
| | pdf |
| www.apple.com/iphone | www |
| | apple |
| | com |
| | iphone |
| www.amazon.com/tag/iphone | www |
| | amazon |
| | com |
| | tag |
| | iphone |
| att.com | att |
| | com |
| www.saiga-jp.com/kanji_dictionary.html | www |
| | saiga |
| | jp |
| | com |
| | kanji |
| | dictionary |
| | html |
| nihongo.j-talk.com | nihongo |
| | j |
| | talk |
| | com |
| www.myspace.com/name | www |
| | myspace |
| | com |
| | name |

In particular embodiments, only some of the punctuation marks in each of the clicked URLs are used as dividers to segment the clicked URL. One reason may be to adjust the segments obtained from the clicked URLs so that they are more suitable to be used to improve the ranking functionalities of a search engine. In particular embodiments, the segments obtained from segmenting the clicked URLs may be categorized into different groups, such as, for example and without limitation, domain segments, host segments, language segments, region segments, path segments, etc.

A domain name is an identification label to define a realm of administrative autonomy, authority, or control on the Internet based on the Domain Name System (DNS). Domain names are organized into a hierarchy. At the top level is the predefined categories such as “com”, “net”, “org” “edu”, “gov”. The subsequent levels may be reserved by the individual entities. In particular embodiments, each clicked URL has a domain segment that is the domain name of the particular clicked URL. Thus, when segmenting the clicked URLs, particular embodiments maintain each domain name found in each of the clicked URLs as one segment, even though there may be punctuation marks within a domain name. For example, the domain name in example clicked URL “www.irs.gov/pub/irs-pdf/f1040.pdf” is “irs.gov”. Thus, when segmenting this particular example clicked URL, “irs.gov” is maintained as a single domain segment even though there is a punctuation mark, “.”, between “irs” and “gov”. In this case, the punctuation mark “.” does not divide the domain name “irs.gov” into two separate segments. Sometimes, a domain name may be hyphenated words. For example, the domain name in example clicked URL “www.saiga-jp.com/kanji_dictionary.html” is “saiga-jp.com”, which is maintained as a single domain segments instead of three separate segments as illustrated in TABLE 3A.

A host name, or hostname, is a unique name by which a network-attached device is known on a network. Sometimes, a clicked URL may include a host name. For example, in the example clicked URL “nihongoj-talk.com”, “j-talk.com” is the domain name and “nihongo” is the host name. In this case, “j-talk.com” may be the domain segment and “nihongo” may be the host segment. Note that not all clicked URLs have host segments.

The language is the language of the clicked URL. In particular embodiments, each clicked URL has a language segment that indicates the language of the particular clicked URL. Sometimes, a URL may include a language portion. In this case, the language segment is determined based on the language portion of the clicked URL. For example, the website “www.wikipedia.org” supports multiple languages. For information in English, one may go to “en.wikipeidia.org”; for information in Chinese, one may go to “zh.wikipedia.org”; for information in French, one may go to “fr.wikipedia.org”; and so on. The portions “en”, “zh”, and “fr” indicate the languages of these URLs respectively and may be used as the language segments of these URLs. In example clicked URL “www.saiga-jp.com/kanji_dictionary.html”, the portion “jp” indicates that the language of this example clicked URL is Japanese. Thus, the language segment of this particular example clicked URL is “jp”. If a clicked URL does not have a language portion, particular embodiments may assume that the language segment of the clicked URL is “en”, representing English.

The geographical region is the region, e.g., the country, of the clicked URL. In particular embodiments, each clicked URL has a region segment that indicates the geographical region of the particular clicked URL. Currently, almost all of the countries in the world each have a two-character country code. Sometimes, a URL may include a region portion, e.g., a country code. In this case, the region segment is determined based on the region portion of the clicked URL. For example, the website “www.fedex.com” support multiple countries. For the United States, one may go to “www.fedex.com/us”; for Japan, one may go to “www.fedex.com/jp”; for Austria, one may go to “www.fedex.com/at”; and so on. The portions “us”, “jp”, and “at” indicate the countries of these URLs respectively and may be used as the region segments of these URLs. Sometimes, the same portion in a clicked URL may be used to determine both the language segment and the region segment of the clicked URL. In example clicked URL “www.saiga-jp.com/kanji_dictionary.html”, the portion “jp” may also indicate that the region of this example clicked URL is Japan. If a clicked URL does not have a region portion, e.g., a country code, particular embodiments may assume that the region segment of the clicked URL is “us”, representing the United States.

In particular embodiments, the language and region segments for each of the optionally normalized clicked URLs may be determined by looking up a predetermined table. Particular embodiments may represent the languages using ISO (International Organization for Standardization) 639-1 codes and the countries or dependent territories using ISO 3166 codes.

The path is the path of the network resources having the clicked URLs. Particular embodiments consider the portion following the domain name after “/” in each of the clicked URLs as the path portion of the clicked URL. Particular embodiments segment the path portion of each of the clicked URLs into one or more path segments divided by punctuation marks. For example, the path portion of example clicked URL “www.saiga-jp.com/kanji_dictionary.html” may be “kanji_dictionary.html” and may be segmented into three path segments: “kanji”, “dictionary” and “html”. Note that not all clicked URLs may have one or more path segments. For example, example clicked URL “www.irs.gov” does not have anything following the domain name, and thus does not have any path segment.

The following TABLE 3B illustrates the segments of the example clicked URLs illustrated in TABLE 1 where each clicked URL has a domain segment, a language segment, a region segment, and zero or more path segments.

TABLE 3B
URL Segments of the Example Clicked URLs

| Clicked URL | URL Segment | |
|---|---|---|
| www.irs.gov | domain segment | irs.gov |
| | language segment | en |
| | region segment | us |
| www.irs.gov/pub/irs-pdf/f1040.pdf | domain segment | irs.gov |
| | language segment | en |
| | region segment | us |
| | path segment | pub |
| | | irs |
| | | pdf |
| | | f1040 |
| | | pdf |
| www.irs.gov/pub/irs-pdf/f1040es.pdf | domain segment | irs.gov |
| | language segment | en |
| | region segment | us |
| | path segment | pub |
| | | irs |
| | | pdf |
| | | f1040es |
| | | pdf |
| www.apple.com/iphone | domain segment | apple.com |
| | language segment | en |
| | region segment | us |
| | path segment | iphone |
| www.amazon.com/tag/iphone | domain segment | amazon.com |
| | language segment | en |
| | region segment | us |
| | path segment | tag |
| | | iphone |
| att.com | domain segment | att.com |
| | language segment | en |
| | region segment | us |
| www.saiga-jp.com/ | domain segment | saiga-jp.com |
| kanji_dictionary.html | language segment | jp |
| | region segment | jp |
| | path segment | kanji |
| | | dictionary |
| | | html |
| nihongo.j-talk.com | domain segment | aj-talk.com |
| | host segment | nihongo |
| | language segment | jp |
| | region segment | jp |
| www.myspace.com/name | domain segment | myspace.com |
| | language segment | en |
| | region segment | us |
| | path segment | name |

Once the query segments and the URL segments have been obtained from the optionally normalized search queries and clicked URLs, particular embodiments construct a dictionary based on the query segments and the URL segments, as illustrated in step 240. In particular embodiments, the dictionary includes one or more query-URL n-grams.

In general, an n-gram is a subsequence of n items from a given sequence. An n-gram of size 1 is referred to as a “unigram”, of size 2 is referred to as a “bigram” or “digram”, and of size 3 is referred to as a “trigram”. In particular embodiments, each query-URL n-gram includes a query part and a URL part. Hereafter, let (q, u) denote a query-URL n-gram, where q is the query part and u is the URL part. For a particular query-URL n-gram, its query part, q, may include one or more query segments and may be referred to as “query n-gram”, and its URL part, u, may include one or more URL segments and may be referred to as “URL n-gram”. In this case, the items in the query-URL n-grams are the query segments or the URL segments. For example, if one query segment is included in the query part of a query-URL n-gram, then the query n-gram is a query unigram. If two query segments are included in the query part of a query-URL n-gram, then the query n-gram is a query bigram. If three query segments are included in the query part of a query-URL n-gram, then the query n-gram is a query trigram. The same concept applies to the URL part of a query-URL n-gram. Note that for a particular query-URL n-gram, its query part and URL part may include different numbers of query segments and URL segments respectively.

In particular embodiments, for a query-URL n-gram, its query part and URL part may include the query segments and the URL segments obtained from the same pair of search query and clicked URL. Consequently, from the query segments and the URL segments of each pair of search query and clicked URL, one or more query-URL n-grams may be constructed

Using example pair <irs 1040 form, www.irs.gov/pub/irs-pdf/f1040.pdf> to illustrate the construction of the query-URL n-grams, there are three query segments obtained from example search query “irs 1040 form” as illustrated in TABLE 2 and eight URL segments obtained from example clicked URL “www.irs.gov/pub/irs-pdf/f1040.pdf” as illustrated in TABLE 3B. Note that the URL segments obtained from each clicked URL may include a domain segment, zero or one host segment, a language segment, a region segment, and zero or more path segments. Particular embodiments may construct each query-URL n-gram by selecting n₁ query segments for the query part and n₂ URL segments for the URL part of the query-URL n-gram, where n₁ denotes an integer between 1 and the total number of query segments, in this case 3; and n₂ denotes an integer between 1 and the total number of URL segments, in this case 8.

Examples of the query-URL n-grams that may be constructed from the query segments and the URL segments obtained from example pair <irs 1040 form, www.irs.gov/pub/irs-pdf/f1040.pdf> may include, non-exhaustively:

(1) (irs, irs.gov), where “irs” is the query part, which includes one query segment, and “irs.gov” is the URL part, which includes the domain segment;

(2) (irs 1040, irs.gov), where “irs 1040” is the query part, which includes two query segments, and “irs.gov” is the URL part, which includes the domain segment;

(3) (irs 1040 form. irs.gov), where “irs 1040 form” is the query part, which includes three query segments, and “irs.gov” is the URL part, which includes the domain segment;

(4) (form, en), where “form” is the query part, which includes one query segment, and “en” is the URL part, which includes the language segment;

(5) (1040 form, en), where “1040 form” is the query part, which includes two query segments, and “en” is the URL part, which includes the language segment;

(6) (1040, us), where “1040” is the query part, which includes one query segment, and “us” is the URL part, which includes the region segment;

(7) (irs form, us), where “irs form” is the query part, which includes two query segments, and “us” is the URL part, which includes the region segment;

(8) (irs 1040 form, pub), where “irs 1040 form” is the query part, which includes three query segments, and “pub” is the URL part, which includes one path segment;

(9) (irs 1040, pdf f1040), where “irs 1040” is the query part, which includes two query segments, and “pdf f1040” is the URL part, which includes two path segments;

(10) (irs 1040, irs.gov pub f1040), where “irs 1040” is the query part, which includes two query segments, and “irs.gov pub f1040” is the URL part, which includes the domain segment and two path segments; and

(11) (1040 form, irs.gov en us pub), where “1040 form” is the query part, which includes two query segments, and “irs.gov en us pub” is the URL part, which includes the domain segment, the language segment, the region segment, and one path segment.

Particular embodiments may separate the domain segment, the host segment, the language segment, the region segment, and the path segment, such that for a particular query-URL n-gram, its URL part may only include the domain segment, or the host segment, or the language segment, or the region segment, or one or more path segments. In this case, example query-URL n-grams (10) and (11) above may not be chosen as query-URL n-grams because the URL part of each of these two query-URL n-grams includes a combination of domain segment, host segment, language segment, region segment, or path segment.

Due to the different combinations, there may be many query-URL n-grams constructed from the query segments and the URL segments obtained from a single pair of search query and clicked URL. To avoid over-fitting, particular embodiments may limit the number of query segments or URL segment that may be included in the query part or the URL part of each query-URL n-gram. For example, in particular embodiments, the query part and the URL part of each query-URL n-gram may each include at most three query segments and URL segments respectively, i.e., query trigram and URL trigram.

Particular embodiments calculate an association score for each query-URL n-gram constructed, also as illustrated in step 250. The association score may indicate the level of similarity between the query part and the URL part of the query-URL n-gram. There may be many different ways to calculate the association scores. The present disclosure contemplates any suitable method to calculate an association score for a query-URL n-gram.

In particular embodiment, an association score may be a mutual information (MI) score, hereafter denoted as MI(q, u). There are different formulas that may be used to calculate the MI scores, and the present disclosure contemplates any suitable MI formulas.

For example, the MI score of a query-URL n-gram may be calculated as:

$$M I ( q , u ) = {log}_{2} \frac{frequency ( q , u )}{freqency ( q ) frequency ( u )} ,$$

where: (1) frequency (q, u) is the number of times, i.e., the frequency, q is found in the search query and u is found in the clicked URL of the same pair of search query and clicked URL among all the pairs of search query and clicked URL; (2) frequency (q) is the number of times, i.e., the frequency, q is found in the search queries of all the pairs of search query and clicked URL; and (3) frequency (u) is the number of times, i.e., the frequency, u is found in the clicked URLs of all the pairs of search query and clicked URL. Note that if a particular (q, u), q, or u is not found in the appropriate parts of any pair of search query and clicked URL, then the frequency value may be set to 0.

Using example query-URL n-gram (irs 1040, irs.gov pdf f1040) to illustrate an MI score calculation, first, frequency (q, u) equals frequency (irs 1040, irs.gov pdf f1040) and is the number of times “irs 1040” is found in the search query and “irs.gov pdf f1040” is found in the clicked URL of the same pair of search query and clicked URL among all of the pairs of search query and clicked URL. Suppose all of the pairs of search query and clicked URL have been included in TABLE 1. Only one pair of search query and clicked URL in TABLE 1, <irs 1040 form, www.irs.gov/pub/irs-pdf/f1040.pdf>, includes “irs 1040” in its search query and “irs.gov pdf f1040” in its clicked URL. Thus, in this case frequency (irs 1040, irs.gov pdf f1040) equals 1.

Second, frequency (q) equals frequency (irs 1040) and is the number of times “irs 1040” is found the search queries of all of the pairs of search query and clicked URL. In TABLE 1, three pairs of search query and clicked URL, <irs 1040 form, www.irs.gov>, <irs 1040 form, www.irs.gov/pub/irs-pdf/f1040.pdf>, and <irs 1040 form, www.irs.gov/pub/irs-pdf/f1040es.pdf>, include “irs 1040” in their search queries. Thus, in this case frequency (irs 1040) equals 3.

Third, frequency (u) equals frequency (irs.gov pdf f1040) and is the number of times “irs.gov pdf f1040” is found in the clicked URLs of all of the pairs of search query and clicked URL. In TABLE 1, only one pair of search query and clicked URL, <irs 1040 form, www.irs.gov/pub/irs-pdf/f1040.pdf>, include “irs.gov pdf f1040” in its clicked URL. Thus, in this case frequency (irs.gov pdf f1040) equals 1.

In another example, the MI score of a query-URL n-gram may be calculated as:

$$M I ( q , u ) = {\sum }_{i ∈ q} {\sum }_{j ∈ u} P ( i , j ) {log}_{2} \frac{P ( i , j )}{P ( i ) P ( j )} .$$

Other statistical models may also be used to calculate the association scores of the query-URL n-grams. For example, particular embodiments may use the chi-square distribution or the chi-square statistic to calculate the association scores of the query-URL n-grams.

The following TABLE 4 illustrates the actual MI scores calculated for some example features sets using actual network traffic data obtained from an actual search engine.

TABLE 4
Examples of Actual Mutual Information Scores

| Query-URL n-gram | | |
|---|---|---|
| Query Part | URL Part | MI Score |
| iphone | apple.com | 8.7713 |
| iphone | amazon.com | −0.1555 |
| iphone plan | att.com | 11.5388 |
| iphone plan | apple.com | 8.9676 |
| form | pdf | 4.9067 |
| form | html | 1.0916 |
| kanji | ja | 11.3862 |
| kanji | zh | 6.2567 |
| kanji | en | 4.2110 |

By examining each query-URL n-gram and its MI score, particular embodiments may evaluate the association between the query part and the URL part of the query-URL n-gram. For example, in TABLE 4, query-URL n-gram (iphone, apple.com) has MI score 8.7713, and query-URL n-gram (iphone, amazon.com) has MI score −0.1555, which suggests that query segment “iphone” may be strongly associated with URL segment “apple.com” but negatively associated with URL segment “amazon.com”. One explanation may be that iPhone as a product is not only developed by Apple Inc. but is also strongly associated with the Apple brand. In contrast, while Amazon.com may sell iPhones, it also sells a large variety of other products, and thus is not regarded as a very authoritative source of information specifically about the iPhones. In this case, “apple.com” may be considered as a preferred URL segment for “iphone” over “amazon.com”.

However, by adding additional context to the query part, the preferred URL segments in the URL part of the query-URL n-grams may change based on the calculated MI scores. For example, in TABLE 4, query-URL n-gram (iphone plan, att.com) has MI score 11.5388, and query-URL n-gram (iphone plan, apple.com) has MI score 8.9676. In comparison to the two examples above, the query part of these two query-URL n-grams has an additional segment, “plan”, which may be considered as additional context to “iphone”. The two MI scores indicate that, while “apple.com” is still a strongly preferred URL segment for “iphone plan”, “att.com” may be even more strongly preferred for “iphone plan” since there may be more product information on iPhones at the website “www.apple.com” while information provided at the website “www.att.com” may be more targeted to mobile telephone plans and rates, which may be more relevant to query segment “iphone plan”.

The association scores calculated for the query-URL n-grams may be used in many different applications. For example and without limitation, the association scores may be used to improve the performance of a ranking algorithm implemented by a search engine, as illustrated in step 260.

As explained above, one type of the association scores is the MI scores, which may indicate how strongly or weakly the query segments and the URL segments of the query-URL n-grams are associated. In particular embodiments, it may be reasonable to anticipate that incorporating such associations into a ranking algorithm may help improve both search quality and user experience. For example, for search query “irs 1040 form”, suppose there are two documents identified by the search engine and their URLs are “www.irs.gov/pub/irs-pdf/f1040.pdf” and “www.irs.gov/taxtopics/tc352.html” respectively. The first, “www.irs.gov/pub/irs-pdf/f1040.pdf”, is an Adobe PDF (Portable Document Format) document of the actual 1040 tax form; and the second, “www.irs.gov/taxtopics/tc352.html”, is a web page document having information about the 1040 tax form. Further suppose that both the PDF document and the web page contain the same query relevant keywords. From TABLE 4, it may be determined that the query segment “form” is more strongly associated with the URL segment “pdf” than the URL segment “html” based on the two relevant MI scores 4.9067 and 1.0916. Thus, the ranking algorithm may rank the first PDF document higher than the second web page document.

In particular embodiments, a ranking algorithm may be trained using the MI scores. Machine learning is the process of training computers to learn to perform certain functionalities. Typically, an algorithm is designed and trained by applying training data to the algorithm. The algorithm is adjusted, i.e., improved, based on how it responds to the training data. Often, multiple sets of training data may be applied to the same algorithm so that the algorithm may be repeatedly improved.

One type of algorithm of machine learning is transduction, also known as transductive inference. Typically, such an algorithm may predict an output in response to an input. To train such an algorithm, for example, the training data may include training inputs and training outputs. The training outputs may be the desirable or correct outputs that should be predicted by the algorithm. By comparing the outputs predicted by the algorithm in response to the training inputs with the training outputs, the algorithm may be appropriately improved so that, in response to the training inputs, the algorithm predicts outputs that are the same as or similar to the training outputs. In particular embodiments, the type of training inputs and training outputs in the training data may be similar to the type of actual inputs and actual outputs to which the algorithm is to be applied.

Transduction machine learning has many applications, one of which is in the field of search engines, and more specifically, the ranking algorithms implemented by the search engines. In particular embodiments, a ranking algorithm may be a supervised learning algorithm that uses boosted decision trees and incorporates the pair-wise information from the training data. Such ranking algorithm is sometimes referred to as “GBRank” (Gradient Boosting Rank). Machine learning with GBRank is described in more detail in A regression framework for learning ranking functions using relative relevance judgments, by Zhaohui Zheng, Hongyuan Zha, Keke Chen, and Gordon Sun, Proceedings of SIGIR 30. GBRank may be able to deal with a large amount of training data with hundreds of features.

Particular embodiments use Discounted Cumulative Gain (DCG) to evaluate the ranking accuracy of GBRank. DCG may be defined as:

$$D C {G}_{k} = {\sum }_{i = 1}^{k} \frac{{G}_{i}}{{log}_{2} ( i + 1 )} ,$$

where Gᵢ represents the editorial judgment of the i-th network resource. Evaluating ranking accuracy using DCG is described in more detail in Cumulated gain-based evaluation of IR techniques, by Kalervo Järvelin and Jaana Kekäläinen, Journal ACM Transactions on Information Systems, 20:422-446.

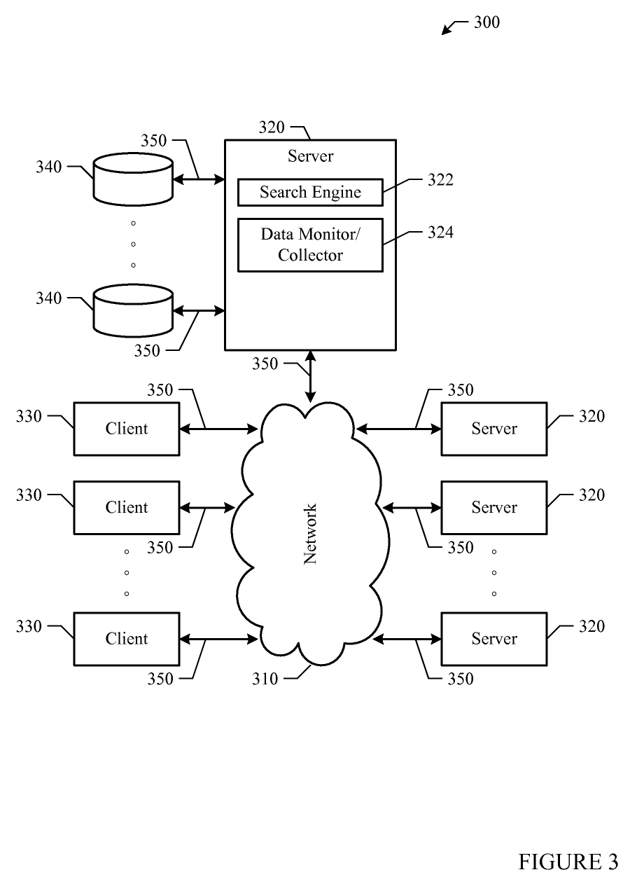

Particular embodiments may be implemented in a network environment. FIG. 3 illustrates an example network environment 300. Network environment 300 includes a network 310 coupling one or more servers 320 and one or more clients 330 to each other. In particular embodiments, network 310 is an intranet, an extranet, a virtual private network (VPN), a local area network (LAN), a wireless LAN (WLAN), a wide area network (WAN), a metropolitan area network (MAN), a communications network, a satellite network, a portion of the Internet, or another network 310 or a combination of two or more such networks 310. The present disclosure contemplates any suitable network 310.

One or more links 350 couple servers 320 or clients 330 to network 310. In particular embodiments, one or more links 350 each includes one or more wired, wireless, or optical links 350. In particular embodiments, one or more links 350 each includes an intranet, an extranet, a VPN, a LAN, a WLAN, a WAN, a MAN, a communications network, a satellite network, a portion of the Internet, or another link 350 or a combination of two or more such links 350. The present disclosure contemplates any suitable links 350 coupling servers 320 and clients 330 to network 3 10.

In particular embodiments, each server 320 may be a unitary server or may be a distributed server spanning multiple computers or multiple datacenters. Servers 320 may be of various types, such as, for example and without limitation, web server, news server, mail server, message server, advertising server, file server, application server, exchange server, database server, or proxy server. In particular embodiments, each server 320 may include hardware, software, or embedded logic components or a combination of two or more such components for carrying out the appropriate functionalities implemented or supported by server 320. For example, a web server is generally capable of hosting websites containing web pages or particular elements of web pages. More specifically, a web server may host HTML files or other file types, or may dynamically create or constitute files upon a request, and communicate them to clients 330 in response to HTTP or other requests from clients 330. A mail server is generally capable of providing electronic mail services to various clients 330. A database server is generally capable of providing an interface for managing data stored in one or more data stores.

In particular embodiments, each client 330 may be an electronic device including hardware, software, or embedded logic components or a combination of two or more such components and capable of carrying out the appropriate functionalities implemented or supported by client 330. For example and without limitation, a client 330 may be a desktop computer system, a notebook computer system, a netbook computer system, a handheld electronic device, or a mobile telephone. A client 330 may enable an network user at client 330 to access network 310. A client 330 may have a web browser, such as Microsoft Internet Explorer or Mozilla Firefox, and may have one or more add-ons, plug-ins, or other extensions, such as Google Toolbar or Yahoo Toolbar. A client 330 may enable its user to communicate with other users at other clients 330. The present disclosure contemplates any suitable clients 330.

In particular embodiments, one or more data storages 340 may be communicatively linked to one or more severs 320 via one or more links 350. In particular embodiments, data storages 340 may be used to store various types of information. In particular embodiments, the information stored in data storages 340 may be organized according to specific data structures. Particular embodiments may provide interfaces that enable servers 320 or clients 330 to manage, e.g., retrieve, modify, add, or delete, the information stored in data storage 340.

In particular embodiments, a server 320 may include a search engine 322. Search engine 322 may include hardware, software, or embedded logic components or a combination of two or more such components for carrying out the appropriate functionalities implemented or supported by search engine 322. For example and without limitation, search engine 322 may implement one or more search algorithms that may be used to identify network resources in response to the search queries received at search engine 322, one or more ranking algorithms that may be used to rank the identified network resources, one or more summarization algorithms that may be used to summarize the identified network resources, and so on. The ranking algorithms implemented by search engine 322 may be trained using the set of the training data constructed from pairs of search query and clicked URL.

In particular embodiments, a server 320 may also include a data monitor/collector 324. Data monitor/collection 324 may include hardware, software, or embedded logic components or a combination of two or more such components for carrying out the appropriate functionalities implemented or supported by data collector/collector 324. For example and without limitation, data monitor/collector 324 may monitor and collect network traffic data at sever 320 and store the collected network traffic data in one or more data storage 340. The pairs of search query and clicked URL may then be extracted from the network traffic data.

Particular embodiments may be implemented as hardware, software, or a combination of hardware and software. For example and without limitation, one or more computer systems may execute particular logic or software to perform one or more steps of one or more processes described or illustrated herein. One or more of the computer systems may be unitary or distributed, spanning multiple computer systems or multiple datacenters, where appropriate. The present disclosure contemplates any suitable computer system. In particular embodiments, performing one or more steps of one or more processes described or illustrated herein need not necessarily be limited to one or more particular geographic locations and need not necessarily have temporal limitations. As an example and not by way of limitation, one or more computer systems may carry out their functions in “real time,” “offline,” in “batch mode,” otherwise, or in a suitable combination of the foregoing, where appropriate. One or more of the computer systems may carry out one or more portions of their functions at different times, at different locations, using different processing, where appropriate. Herein, reference to logic may encompass software, and vice versa, where appropriate. Reference to software may encompass one or more computer programs, and vice versa, where appropriate. Reference to software may encompass data, instructions, or both, and vice versa, where appropriate. Similarly, reference to data may encompass instructions, and vice versa, where appropriate.

One or more computer-readable storage media may store or otherwise embody software implementing particular embodiments. A computer-readable medium may be any medium capable of carrying, communicating, containing, holding, maintaining, propagating, retaining, storing, transmitting, transporting, or otherwise embodying software, where appropriate. A computer-readable medium may be a biological, chemical, electronic, electromagnetic, infrared, magnetic, optical, quantum, or other suitable medium or a combination of two or more such media, where appropriate. A computer-readable medium may include one or more nanometer-scale components or otherwise embody nanometer-scale design or fabrication. Example computer-readable storage media include, but are not limited to, compact discs (CDs), field-programmable gate arrays (FPGAs), floppy disks, floptical disks, hard disks, holographic storage devices, integrated circuits (ICs) (such as application-specific integrated circuits (ASICs)), magnetic tape, caches, programmable logic devices (PLDs), random-access memory (RAM) devices, read-only memory (ROM) devices, semiconductor memory devices, and other suitable computer-readable storage media.

Software implementing particular embodiments may be written in any suitable programming language (which may be procedural or object oriented) or combination of programming languages, where appropriate. Any suitable type of computer system (such as a single- or multiple-processor computer system) or systems may execute software implementing particular embodiments, where appropriate. A general-purpose computer system may execute software implementing particular embodiments, where appropriate.

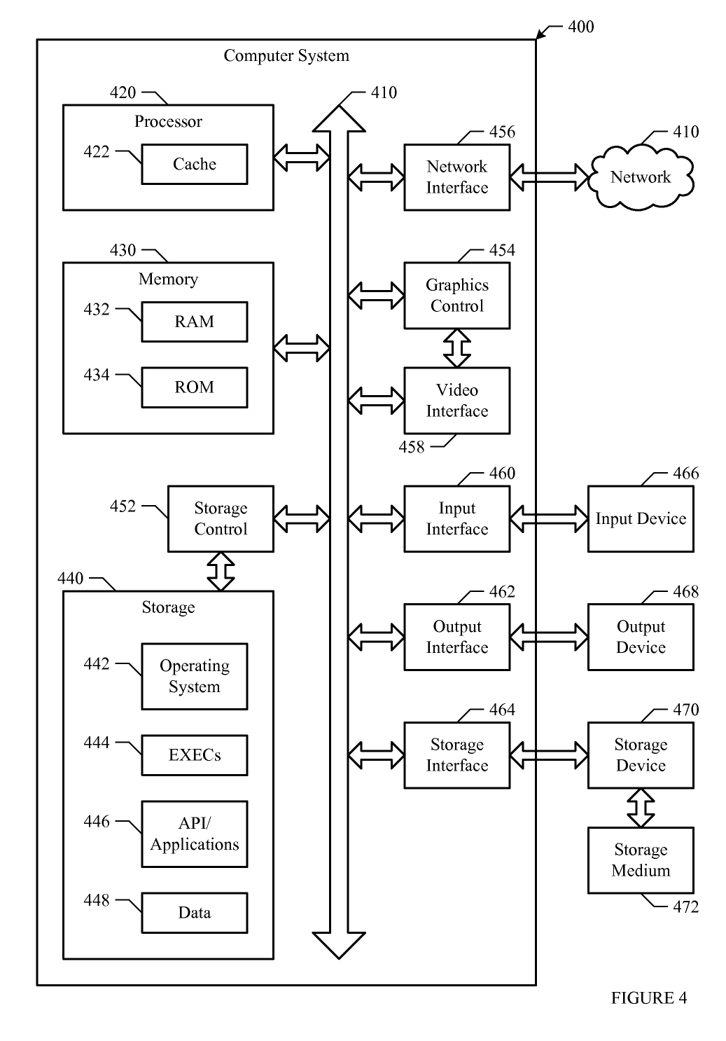

For example, FIG. 4 illustrates an example computer system 400 suitable for implementing one or more portions of particular embodiments. Although the present disclosure describes and illustrates a particular computer system 400 having particular components in a particular configuration, the present disclosure contemplates any suitable computer system having any suitable components in any suitable configuration. Moreover, computer system 400 may have take any suitable physical form, such as for example one or more integrated circuit (ICs), one or more printed circuit boards (PCBs), one or more handheld or other devices (such as mobile telephones or PDAs), one or more personal computers, or one or more super computers.

System bus 410 couples subsystems of computer system 400 to each other. Herein, reference to a bus encompasses one or more digital signal lines serving a common function. The present disclosure contemplates any suitable system bus 410 including any suitable bus structures (such as one or more memory buses, one or more peripheral buses, one or more a local buses, or a combination of the foregoing) having any suitable bus architectures. Example bus architectures include, but are not limited to, Industry Standard Architecture (ISA) bus, Enhanced ISA (EISA) bus, Micro Channel Architecture (MCA) bus, Video Electronics Standards Association local (VLB) bus, Peripheral Component Interconnect (PCI) bus, PCI-Express bus (PCI-X), and Accelerated Graphics Port (AGP) bus.

Computer system 400 includes one or more processors 420 (or central processing units (CPUs)). A processor 420 may contain a cache 422 for temporary local storage of instructions, data, or computer addresses. Processors 420 are coupled to one or more storage devices, including memory 430. Memory 430 may include random access memory (RAM) 432 and read-only memory (ROM) 434. Data and instructions may transfer bidirectionally between processors 420 and RAM 432. Data and instructions may transfer unidirectionally to processors 420 from ROM 434. RAM 432 and ROM 434 may include any suitable computer-readable storage media.

Computer system 400 includes fixed storage 440 coupled bi-directionally to processors 420. Fixed storage 440 may be coupled to processors 420 via storage control unit 452. Fixed storage 440 may provide additional data storage capacity and may include any suitable computer-readable storage media. Fixed storage 440 may store an operating system (OS) 442, one or more executables 444, one or more applications or programs 446, data 448, and the like. Fixed storage 440 is typically a secondary storage medium (such as a hard disk) that is slower than primary storage. In appropriate cases, the information stored by fixed storage 440 may be incorporated as virtual memory into memory 430.

Processors 420 may be coupled to a variety of interfaces, such as, for example, graphics control 454, video interface 458, input interface 460, output interface 462, and storage interface 464, which in turn may be respectively coupled to appropriate devices. Example input or output devices include, but are not limited to, video displays, track balls, mice, keyboards, microphones, touch-sensitive displays, transducer card readers, magnetic or paper tape readers, tablets, styli, voice or handwriting recognizers, biometrics readers, or computer systems. Network interface 456 may couple processors 420 to another computer system or to network 410. With network interface 456, processors 420 may receive or send information from or to network 410 in the course of performing steps of particular embodiments. Particular embodiments may execute solely on processors 420. Particular embodiments may execute on processors 420 and on one or more remote processors operating together.

In a network environment, where computer system 400 is connected to network 410, computer system 400 may communicate with other devices connected to network 410. Computer system 400 may communicate with network 410 via network interface 456. For example, computer system 400 may receive information (such as a request or a response from another device) from network 410 in the form of one or more incoming packets at network interface 456 and memory 430 may store the incoming packets for subsequent processing. Computer system 400 may send information (such as a request or a response to another device) to network 410 in the form of one or more outgoing packets from network interface 456, which memory 430 may store prior to being sent. Processors 420 may access an incoming or outgoing packet in memory 430 to process it, according to particular needs.

Computer system 400 may have one or more input devices 466 (which may include a keypad, keyboard, mouse, stylus, etc.), one or more output devices 468 (which may include one or more displays, one or more speakers, one or more printers, etc.), one or more storage devices 470, and one or more storage medium 472. An input device 466 may be external or internal to computer system 400. An output device 468 may be external or internal to computer system 400. A storage device 470 may be external or internal to computer system 400. A storage medium 472 may be external or internal to computer system 400.

Particular embodiments involve one or more computer-storage products that include one or more computer-readable storage media that embody software for performing one or more steps of one or more processes described or illustrated herein. In particular embodiments, one or more portions of the media, the software, or both may be designed and manufactured specifically to perform one or more steps of one or more processes described or illustrated herein. In addition or as an alternative, in particular embodiments, one or more portions of the media, the software, or both may be generally available without design or manufacture specific to processes described or illustrated herein. Example computer-readable storage media include, but are not limited to, CDs (such as CD-ROMs), FPGAs, floppy disks, floptical disks, hard disks, holographic storage devices, ICs (such as ASICs), magnetic tape, caches, PLDs, RAM devices, ROM devices, semiconductor memory devices, and other suitable computer-readable storage media. In particular embodiments, software may be machine code which a compiler may generate or one or more files containing higher-level code which a computer may execute using an interpreter.

As an example and not by way of limitation, memory 430 may include one or more computer-readable storage media embodying software and computer system 400 may provide particular functionality described or illustrated herein as a result of processors 420 executing the software. Memory 430 may store and processors 420 may execute the software. Memory 430 may read the software from the computer-readable storage media in mass storage device 430 embodying the software or from one or more other sources via network interface 456. When executing the software, processors 420 may perform one or more steps of one or more processes described or illustrated herein, which may include defining one or more data structures for storage in memory 430 and modifying one or more of the data structures as directed by one or more portions the software, according to particular needs. In addition or as an alternative, computer system 400 may provide particular functionality described or illustrated herein as a result of logic hardwired or otherwise embodied in a circuit, which may operate in place of or together with software to perform one or more steps of one or more processes described or illustrated herein. The present disclosure encompasses any suitable combination of hardware and software, according to particular needs.

Although the present disclosure describes or illustrates particular operations as occurring in a particular order, the present disclosure contemplates any suitable operations occurring in any suitable order. Moreover, the present disclosure contemplates any suitable operations being repeated one or more times in any suitable order. Although the present disclosure describes or illustrates particular operations as occurring in sequence, the present disclosure contemplates any suitable operations occurring at substantially the same time, where appropriate. Any suitable operation or sequence of operations described or illustrated herein may be interrupted, suspended, or otherwise controlled by another process, such as an operating system or kernel, where appropriate. The acts can operate in an operating system environment or as stand-alone routines occupying all or a substantial part of the system processing.

The present disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend.

What is claimed is:

1. A method comprising:
accessing, by one or more computer systems, one or more pairs of search query and clicked Uniform Resource Location (URL), the clicked URL identifying a network resource that has been identified by a search engine in response to the search query, the clicked URL having been clicked by a user who has issued the search query to the search engine; and
for each of the pairs of search query and clicked URL, by the one or more computer systems,
segmenting the search query into one or more query segments;
segmenting the clicked URL into one or more URL segments;
constructing one or more query-URL n-grams, each of which comprises a query part and a URL part, the query part comprising at least one of the query segments, the URL part comprising at least one of the URL segments; and
calculating one or more association scores each of which for one of the query-URL n-grams, for each of the query-URL n-grams, its association score represents a similarity between the query part and the URL part of the query-URL n-gram and is calculated based on a first frequency of the query part and the URL part of the query-URL n-gram appearing in all of the pairs of search query and clicked URL, a second frequency of the query part of the query-URL n-gram appearing in all of the search queries of all of the pairs of search query and clicked URL, and a third frequency of the URL part of the query-URL n-gram appearing in all of the clicked URLs of all of the pairs of search query and clicked URL.

2. The method of claim 1, wherein for each of the query-URL n-gram, its association score is a mutual information (MI) score and is calculated as:
$$M I ( q , u ) = {log}_{2} \frac{frequency ( q , u )}{freqency ( q ) frequency ( u )} ,$$
where:
q denotes the query part of the query-URL n-gram,
u denotes the URL part of the query-URL n-gram,
MI(q, u) denotes the MI score calculated for the query-URL n-gram,
frequency (q, u) denotes the first frequency of the query part and the URL part of the query-URL n-gram appearing in all of the pairs of search query and clicked URL,
frequency (q) denotes the second frequency of the query part of the query-URL n-gram appearing in all of the search queries of all of the pairs of search query and clicked URL, and
frequency (u) denotes the third frequency of the URL part of the query-URL n-gram appearing in all of the clicked URLs of all of the pairs of search query and clicked URL.

3. The method of claim 1, wherein for each of the pairs of search query and clicked URL, the URL segments comprise a domain segment, zero or more host segment, a language segment, a region segment, and zero or more path segments.

4. The method of claim 3, wherein for each of the query-URL n-grams constructed from the query segments and the URL segments of each of the pairs of search query and clicked URL, the URL part of the query-URL n-gram comprises the domain segment, or the host segment, or the language segment, or the region segment, or at least one of the path segments of the corresponding pair of search query and clicked URL.

5. The method of claim 1, further comprising, for each of the pairs of search query and clicked URL, by the one or more computer systems, normalizing the search query by replacing one or more punctuation marks in the search query with one or more spaces.

6. The method of claim 1, further comprising improving, by the one or more computer systems, a ranking algorithm using the association scores, wherein for a search query and a plurality of network resources identified in response to the search query, the ranking algorithm predicts a ranking of the network resources according to their relative degrees of relevance with respect to the search query.

7. One or more computer-readable storage media embodying software operable when executed by one or more computer systems to:
access one or more pairs of search query and clicked Uniform Resource Location (URL), the clicked URL identifying a network resource that has been identified by a search engine in response to the search query, the clicked URL having been clicked by a user who has issued the search query to the search engine; and
for each of the pairs of search query and clicked URL,
segment the search query into one or more query segments;
segment the clicked URL into one or more URL segments;
construct one or more query-URL n-grams, each of which comprises a query part and a URL part, the query part comprising at least one of the query segments, the URL part comprising at least one of the URL segments; and
calculate one or more association scores each of which for one of the query-URL n-grams, for each of the query-URL n-grams, its association score represents a similarity between the query part and the URL part of the query-URL n-gram and is calculated based on a first frequency of the query part and the URL part of the query-URL n-gram appearing in all of the pairs of search query and clicked URL, a second frequency of the query part of the query-URL n-gram appearing in all of the search queries of all of the pairs of search query and clicked URL, and a third frequency of the URL part of the query-URL n-gram appearing in all of the clicked URLs of all of the pairs of search query and clicked URL.

8. The media of claim 7, wherein for each of the query-URL n-gram, its association score is a mutual information (MI) score and is calculated as:
$$M I ( q , u ) = {log}_{2} \frac{frequency ( q , u )}{freqency ( q ) frequency ( u )} ,$$
where:
q denotes the query part of the query-URL n-gram,
u denotes the URL part of the query-URL n-gram,
MI(q, u) denotes the MI score calculated for the query-URL n-gram,
frequency (q, u) denotes the first frequency of the query part and the URL part of the query-URL n-gram appearing in all of the pairs of search query and clicked URL,
frequency (q) denotes the second frequency of the query part of the query-URL n-gram appearing in all of the search queries of all of the pairs of search query and clicked URL, and
frequency (u) denotes the third frequency of the URL part of the query-URL n-gram appearing in all of the clicked URLs of all of the pairs of search query and clicked URL.

9. The media of claim 7, wherein for each of the pairs of search query and clicked URL, the URL segments comprise a domain segment, zero or more host segment, a language segment, a region segment, and zero or more path segments.

10. The media of claim 9, wherein for each of the query-URL n-grams constructed from the query segments and the URL segments of each of the pairs of search query and clicked URL, the URL part of the query-URL n-gram comprises the domain segment, or the host segment, or the language segment, or the region segment, or at least one of the path segments of the corresponding pair of search query and clicked URL.

11. The media of claim 7, wherein the software is operable when executed by one or more computer systems to, for each of the pairs of search query and clicked URL, normalize the search query by replacing one or more punctuation marks in the search query with one or more spaces.

12. The media of claim 7, wherein the software is operable when executed by one or more computer systems to improve a ranking algorithm using the association scores, wherein for a search query and a plurality of network resources identified in response to the search query, the ranking algorithm predicts a ranking of the network resources according to their relative degrees of relevance with respect to the search query.

13. A system comprising:
a memory comprising instructions executable by one or more processors; and
one or more processors coupled to the memory and operable to execute the instructions, the one or more processors being operable when executing the instructions to:
access one or more pairs of search query and clicked Uniform Resource Location (URL), the clicked URL identifying a network resource that has been identified by a search engine in response to the search query, the clicked URL having been clicked by a user who has issued the search query to the search engine; and
for each of the pairs of search query and clicked URL,
segment the search query into one or more query segments;
segment the clicked URL into one or more URL segments;
construct one or more query-URL n-grams, each of which comprises a query part and a URL part, the query part comprising at least one of the query segments, the URL part comprising at least one of the URL segments; and
calculate one or more association scores each of which for one of the query-URL n-grams, for each of the query-URL n-grams, its association score represents a similarity between the query part and the URL part of the query-URL n-gram and is calculated based on a first frequency of the query part and the URL part of the query-URL n-gram appearing in all of the pairs of search query and clicked URL, a second frequency of the query part of the query-URL n-gram appearing in all of the search queries of all of the pairs of search query and clicked URL, and a third frequency of the URL part of the query-URL n-gram appearing in all of the clicked URLs of all of the pairs of search query and clicked URL.

14. The system of claim 13, wherein for each of the query-URL n-gram, its association score is a mutual information (MI) score and is calculated as:
$$M I ( q , u ) = {log}_{2} \frac{frequency ( q , u )}{freqency ( q ) frequency ( u )} ,$$
where:
q denotes the query part of the query-URL n-gram,
u denotes the URL part of the query-URL n-gram,
MI(q, u) denotes the MI score calculated for the query-URL n-gram,
frequency (q, u) denotes the first frequency of the query part and the URL part of the query-URL n-gram appearing in all of the pairs of search query and clicked URL,
frequency (q) denotes the second frequency of the query part of the query-URL n-gram appearing in all of the search queries of all of the pairs of search query and clicked URL, and
frequency (u) denotes the third frequency of the URL part of the query-URL n-gram appearing in all of the clicked URLs of all of the pairs of search query and clicked URL.

15. The system of claim 13, wherein for each of the pairs of search query and clicked URL, the URL segments comprise a domain segment, zero or more host segment, a language segment, a region segment, and zero or more path segments.

16. The system of claim 15, wherein for each of the query-URL n-grams constructed from the query segments and the URL segments of each of the pairs of search query and clicked URL, the URL part of the query-URL n-gram comprises the domain segment, or the host segment, or the language segment, or the region segment, or at least one of the path segments of the corresponding pair of search query and clicked URL.

17. The system of claim 13, wherein the one or more processors are further operable when executing the instructions to, for each of the pairs of search query and clicked URL, normalize the search query by replacing one or more punctuation marks in the search query with one or more spaces.

18. The system of claim 13, wherein the one or more processors are further operable when executing the instructions to improve a ranking algorithm using the association scores, wherein for a search query and a plurality of network resources identified in response to the search query, the ranking algorithm predicts a ranking of the network resources according to their relative degrees of relevance with respect to the search query.
